(19) United States
(12) Patent Application Publication
(10) Pub. No.: US 2015/0266219 A1
(43) Pub. Date: Sep. 24, 2015

(54) BONDING ASSEMBLY

(71) Applicant: Zephyros, Inc., Romeo, MI (US)

(72) Inventors: Jeffery Thomas Shantz, Metamora, MI (US); Milko Dimovski, Clinton Township, MI (US); Joseph M. Batchik, Lake Orion, MI (US)

(21) Appl. No.: 14/663,832

(22) Filed: Mar. 20, 2015

Related U.S. Application Data
(60) Provisional application No. 61/968,093, filed on Mar. 20, 2014.

(51) Int. Cl. B29C 45/14; B60J 1/00

(52) U.S. Cl. CPC B29C 45/14631; B60J 1/007

(57) ABSTRACT

A bonding assembly comprising a polymeric reinforcement member having a curved profile located into a corner of a frame so that the curved profile corresponds to a curve of the corner and the reinforcement member is located at an intersection of two or more frame members and one or more secondary materials is located onto or about the reinforcement member.

### FIELD OF THE INVENTION

The present invention is predicated upon methods and devices for the reinforcement of a joint location, more specifically for reinforcement with a polymeric reinforcement device at a location where two metallic materials meet for creating a smooth reinforced surface.

### BACKGROUND

In the effort to provide lighter weight and more fuel efficient vehicles, the industry has seen an increase in direct contact between a variety of light-weight materials within the vehicle structure. In addition, the light-weight materials may not provide sufficient reinforcement for the vehicle, thus requiring the use of additional reinforcements. As a result, particular attention has been paid to areas where two light-weight materials meet to form a joint.

### SUMMARY OF THE INVENTION

The present invention meets some or all of the above needs by providing a reinforcement device comprising a polymeric carrier for forming a joint area between two materials (which may be metallic materials) such that the reinforcement device provides a reinforced and smooth surface for receiving a secondary material. The present teachings further comprise a method including molding a polymeric reinforcement member having a curved profile, locating the reinforcement member onto a corner of a frame so that the curved profile corresponds to a curve of the corner and the reinforcement member is located at an intersection of two or more frame members and locating a secondary material over the reinforcement member.

The teachings herein further provide that at least one of the two or more frame members may be metallic. At least two of the two or more frame members may be metallic. At least one of the two or more frame members may be steel. At least two of the two or more frame members may be steel. The frame member may be a windshield frame. The polymeric reinforcement member may be formed of a glass-filled nylon material. The polymeric reinforcement member may be formed in an extrusion process or an injection molding process.

The secondary material may be a weather stripping material. The secondary material may be a metallic material. The secondary material may be a textile material. The secondary material may be a polymeric material. The secondary material may be an adhesive material. The secondary material may be an expandable material. The reinforcement member may include one or more spaces for receiving the two or more frame members.

The teachings herein further envision a frame member including two or more reinforcement members, three or more reinforcement members, or even exactly four reinforcement members.

### BRIEF DESCRIPTION OF THE DRAWINGS

FIG. 1 is a perspective view of an illustrative reinforcement member and joint in accordance with the present teachings.

FIG. 2 is a perspective view of an illustrative reinforcement member and joint in accordance with the present teachings.

FIG. 3 is a perspective view of an illustrative reinforcement member and joint in accordance with the present teachings.

FIG. 4 is a back view of an illustrative reinforcement member and joint in accordance with the present teachings.

FIG. 5 is a perspective view of an illustrative reinforcement member and joint in accordance with the present teachings.

FIG. 6 is a perspective view of an illustrative reinforcement member in accordance with the present teachings.

FIG. 7 is a perspective view of an illustrative reinforcement member in accordance with the present teachings.

FIG. 8 is a back view of an illustrative reinforcement member in accordance with the present teachings.

### DETAILED DESCRIPTION

This application is related to and claims the benefit of the filing date of U.S. Provisional Application Ser. No. 61/968,093 filed Mar. 20, 2014, the contents of this application being hereby incorporated by reference for all purposes.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The reinforcement members described by the teachings herein may be located at any joint location within a vehicle body structure. The reinforcement members are preferably formed in a curved configuration, such that they align with any two, three or more frame members for forming a joint between the frame members. The reinforcement member may be formed such that it prevents direct contact between one or more of the frame members that form the joint. This is especially useful in efforts to prevent corrosion when metallic members intersect at joint locations.

The joints may be located about a windshield frame. One or more of the corners of the windshield frame may include a reinforcement member as described herein. Exactly four of the corners of a windshield may include the reinforcement members described herein. Exactly two of the corners of a windshield frame may include the reinforcement member described herein.

The reinforcement members may be used in combination with one or more secondary materials. The secondary materials may include an activatable material that activates when contacted with a required stimulus (e.g., heat, UV light or the like). The secondary materials may include a weather stripping material. Such weather stripping material may be useful for locations such as a windshield frame. The weather stripping material may be one or any combination of a metallic material, a fibrous material, or a polymeric material. The weather stripping material may be used in combination with an activatable material.

The reinforcement member may also be utilized in combination with a means for connecting the reinforcement member to the joint This means may include a mechanical fastening means or an adhesive. A mechanical fastening means may include a weld tab as shown in the figures provided herein. The adhesive may be an activatable adhesive. The reinforcement members may also be utilized in combination with adhesive compositions that are typically utilized for sealing windshield frames.

The reinforcement members may be formed in an injection molding process, which may be a multi-shot injection molding process. The reinforcement members may be formed in an extrusion process, depending upon the cross-sectional shape of the reinforcement member. The reinforcement members may be formed having openings, slots or depressions formed therein for receiving a portion of one or more frame members. The reinforcement member may include such openings, slots or depressions so that when each frame member enters into said opening, slot or depression it is effectively prevented from directly contacting any adjoining frame member. The location of the openings, slots or depressions may be formed to provide improved reinforcement at joint locations where vehicle frames tend to be weakened.

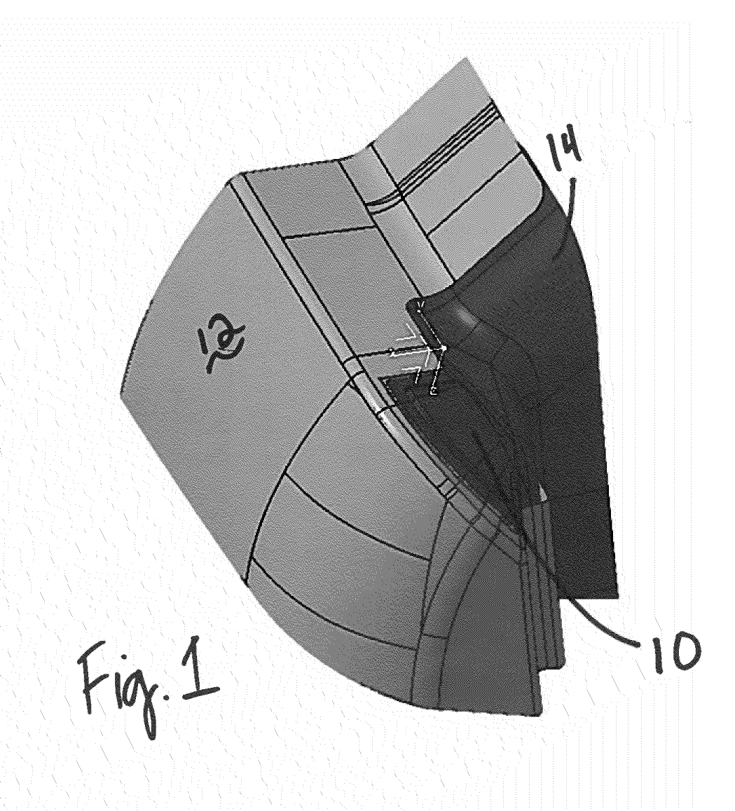

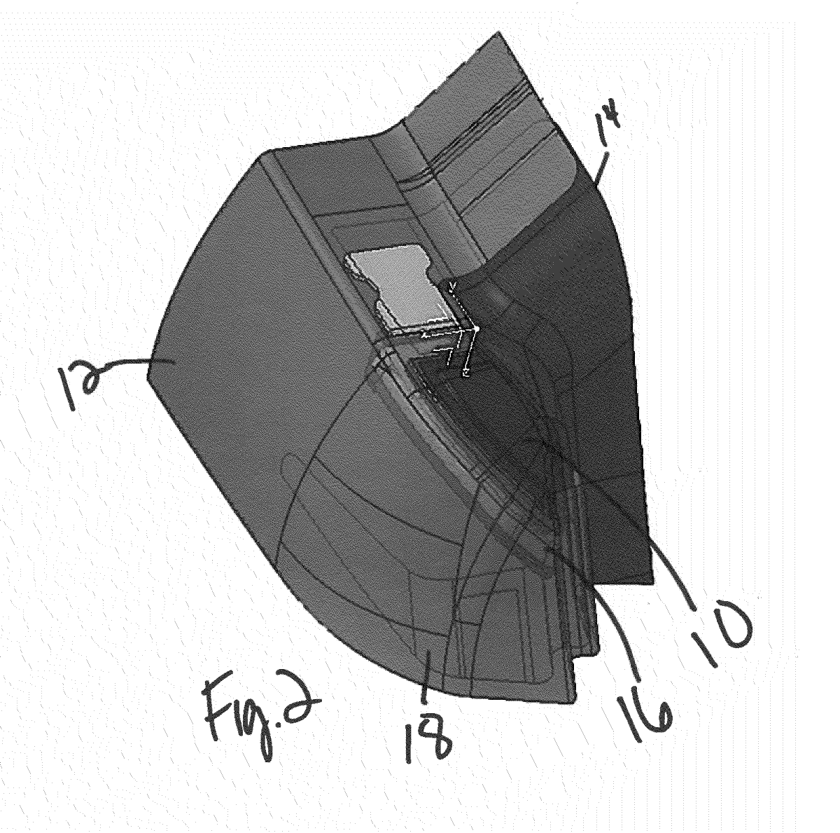

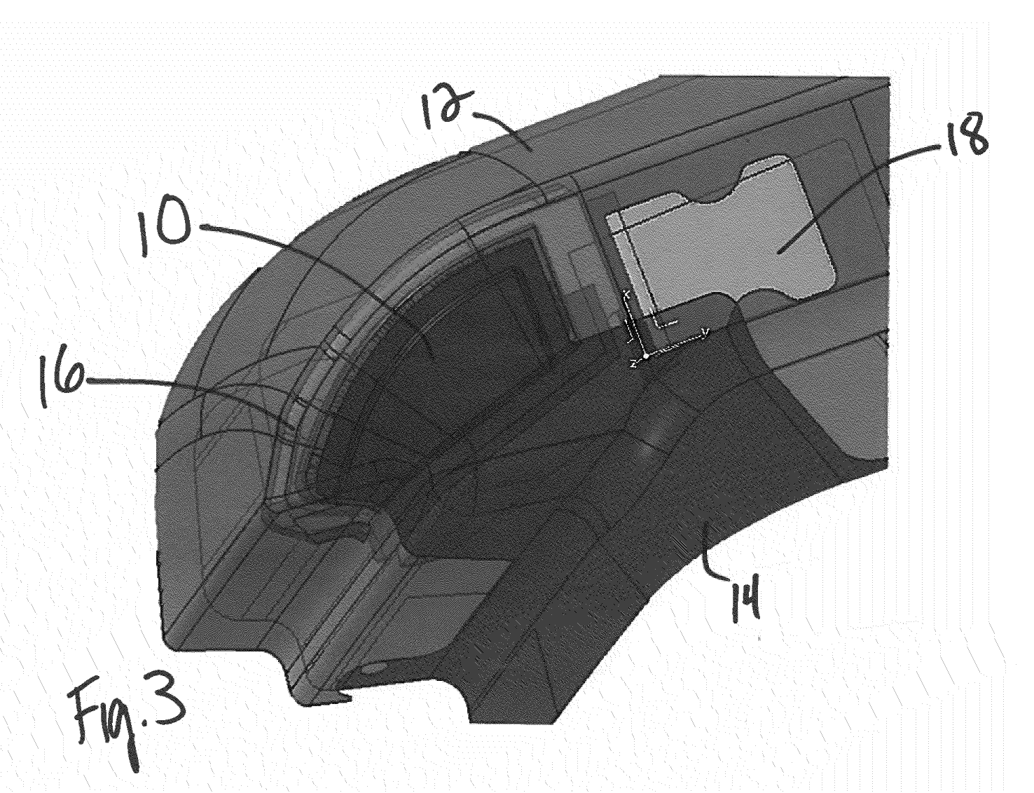

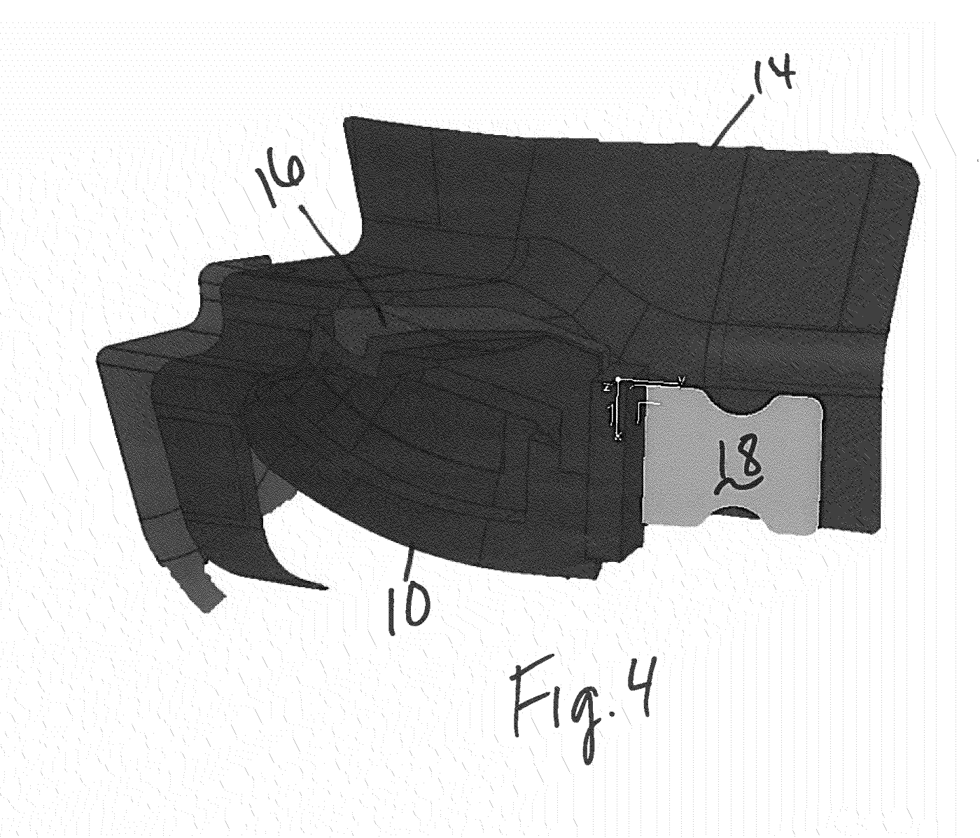

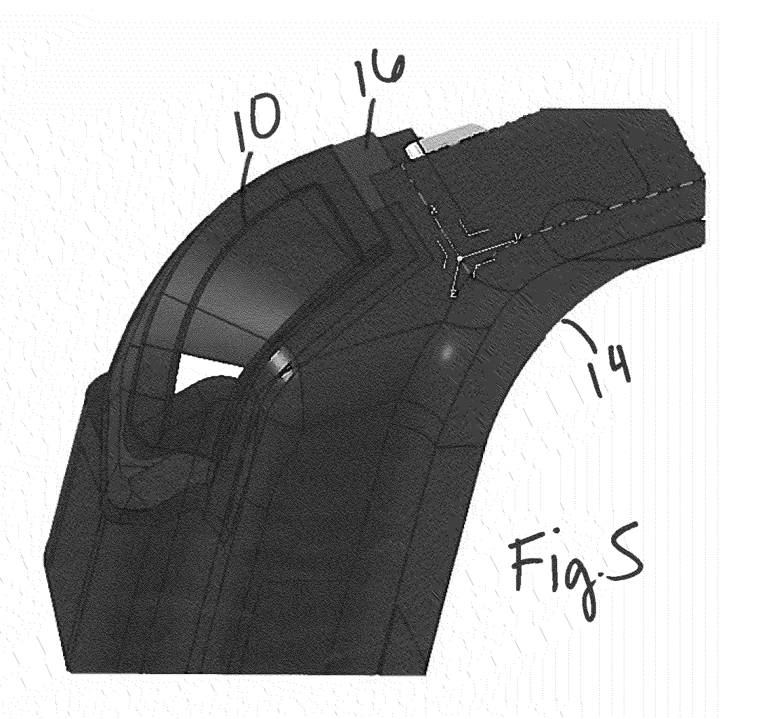

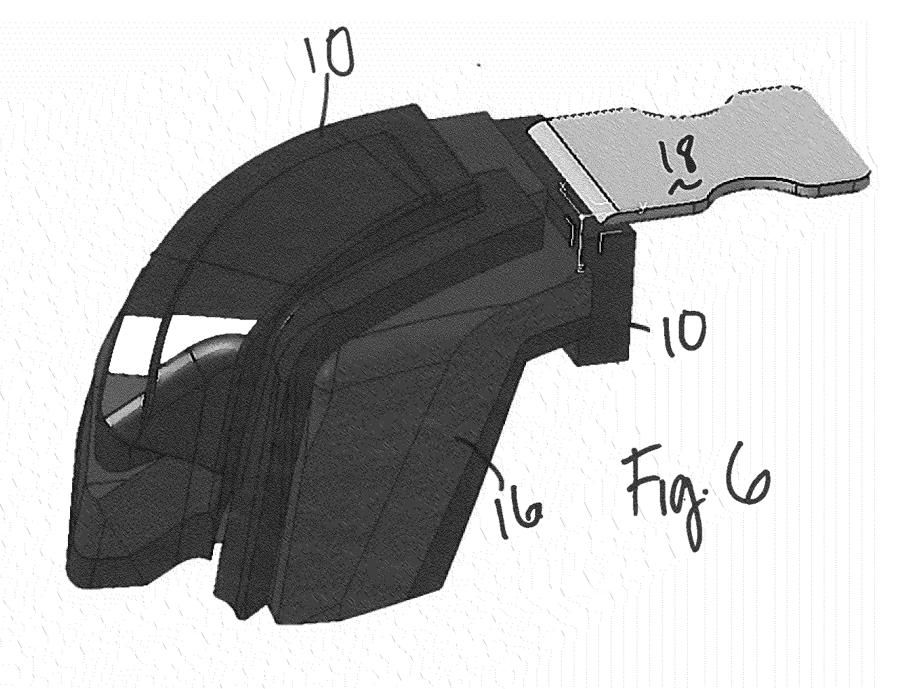

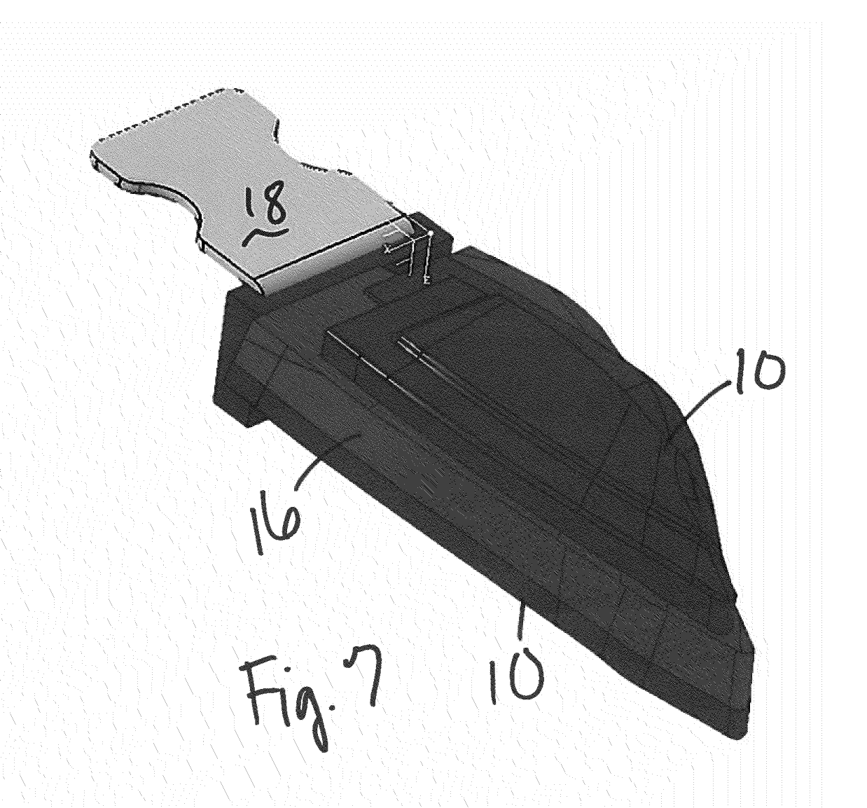

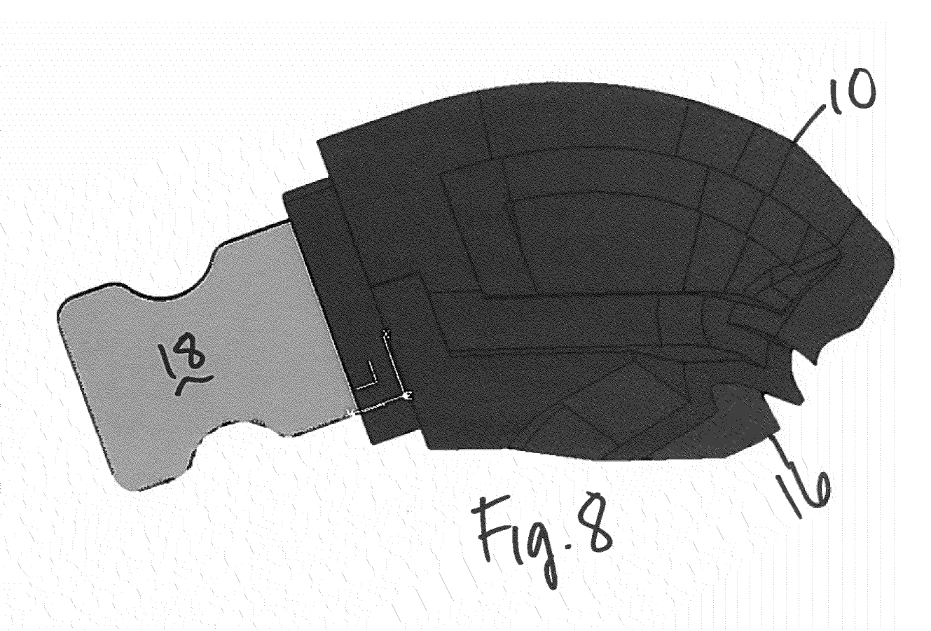

FIG. 1 shows in illustrative reinforcement member 10 located at a joint between a first vehicle frame member 12 and a second vehicle frame member 14. FIG. 2 depicts the same members as FIG. 1 (including the reinforcement member 10, first vehicle member 12 and second vehicle member 14) in addition to a layer of secondary material 16 located onto a surface of the reinforcement member 10. A connection means 18 in the form of a weld tab is also shown underneath the first vehicle frame member 12. FIG. 3 shows top-down view of the reinforcement member 10, the first and second vehicle frame members 12,14, the activatable material 16 and the connection means 18. FIG. 4 shows an underside view of the reinforcement member 10, activatable material 16, connection means 18 and second vehicle member 18. FIG. 5 shows a top-down view of the elements shown at FIG. 4. FIG. 6 shows a perspective view of the reinforcement member 10, connection means 18, and activatable material 16. FIG. 7 shows an alternative perspective view depicting the reinforcement member 10, the activatable material 16 and the connection means 18. FIG. 8 shows a bottom view of the reinforcement member 10, activatable material 16 and connection means 18.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A method comprising
molding a polymeric reinforcement member having a curved profile;
locating the reinforcement member onto a corner of a frame so that the curved profile corresponds to a curve of the corner and the reinforcement member is located at an intersection of two or more frame members;
locating one or more secondary materials over the reinforcement member.

2. The method of claim 1, wherein at least one of the two or more frame members are metallic.

3. The method of claim 1, wherein at least two of the two or more frame members are metallic.

4. The method of claim 1, wherein at least one of the two or more frame members are steel.

5. The method of claim 1, wherein at least two of the two or more frame members are steel.

6. The method of claim wherein the frame member is a windshield frame.

7. The method of claim 1, wherein the polymeric reinforcement member is formed of a glass-filled nylon material.

8. The method of claim 1, wherein the polymeric reinforcement member is formed in an extrusion process or an injection molding process.

9. The method of claim 1, wherein the secondary material is a weather stripping material.

10. The method of claim 1, wherein the secondary material is a metallic material.

11. The method of claim 1, wherein the secondary material is a textile material.

12. The method of claim 1, wherein the secondary material is a polymeric material.

13. The method of claim 1, wherein the secondary material is an adhesive material.

14. The method of claim 1, wherein the secondary material is an expandable (activatable) material.

15. The method of claim 1, wherein the reinforcement member includes one or more spaces for receiving the two or more frame members.

16. A frame member including two or more reinforcement members according to claim 1.

17. The frame member of claim 16, including exactly four reinforcement members.

18. The frame member of claim 16, wherein the frame members form a windshield frame.

19. The frame member of claim 17, wherein the frame members form a windshield frame.
